(19) United States
(12) Patent Application Publication
(10) Pub. No.: US 2002/0024438 A1
(43) Pub. Date: Feb. 28, 2002

(54) Mail check method and system

(76) Inventor: Orin A. Roberson, Houston, TX (US)

Correspondence Address: Darcell Walker, 8107 Carvel Lane, Houston, TX, 77036, US

(21) Appl. No.: 09/941,067

(22) Filed: Aug. 28, 2001

Related U.S. Application Data
(60) Provisional application No. 60/228,835, filed on Aug. 28, 2000.

(51) Int. Cl. G08B 13/14

(52) U.S. Cl. 340/569; 340/540

(57) ABSTRACT

The present invention is a method and system designed to allow the user to determine mail status of a mailbox without having to go to the mailbox. Using the internet, telephone, cell telephone, computer (with special software), computer with website, television website, or a special transmitter/receiver, a person can receive information about the status of the mailbox (if the mailbox contains any mail) regardless of the distance of the user from the said mailbox. The user is able to receive a picture/image of the mailbox's contents from remote locations where picture/image technology is supported and accepted. i.e. Computer, PDA, wireless web devices etc. This allows the user to evaluate the contents of the mailbox/container.

### CROSS REFERENCE TO RELATED APPLICATIONS

This application is related to and claims priority of provisional application 60/228,835 filed on Aug. 28, 2000 and provisional application 60/294,763 filed on May 30, 2001, the contents of which are incorporated by reference herein.

1. Field of the Invention

This invention relates to a system that checks for the presence of mail in a mailbox/container. In particular, this invention relates to a system that electronically checks a mailbox for mail and notifies the owner when mail is present in the mailbox.

2. Background of the Invention

The inventor having had several mailboxes has noticed that is a hassle to go to the mailbox to retrieve the daily mail. The frustration of having to travel to the mailbox is compounded by the fact that a large percent of the time, the mailbox is empty. This situation causes frustration and a waste of time. Mailbox owners that do their business through off-site mailboxes often have to go several miles from their locations, only to find that their boxes are empty. Remotely located Inter-office mailboxes require walking long distances as well.

The current means to determine one's mail status requires the person to physically go to the mailbox or to call a mailbox rental agency's attendant and ask them to look in their mailbox to determine whether they have mail. This process is very unreliable as attendants may be busy and one will have to wait until the attendant is free to look in their mailbox. This system is also not very efficient as you can only check between the usual business hours of 8:00 a.m. to 6:00 p.m.

Other current systems that have been patented have not utilized global computer networks such as the Internet and phone systems as a means of accessing the status of physical mail thus allowing for mail status determination irrespective of distance nor have they allowed the user to visually check their mailbox's contents remotely via picture/image technology. They have not taken into consideration that the unit can be linked to multiple internal and external containers. These units can also be given codes to distinguish which box is to be monitored/checked. Current systems have not initiated the use of pin numbers to ensure privacy via websites and touch tone telephones.

There remains a need for a method and system that will enable an individual to check for the presence of mail content in their mailbox from a remote location to the mailbox.

### SUMMARY OF THE INVENTION

It is an objective of the present invention to provide a method and system that will enable a user to check for mail content in a mailbox from a remote location and without visiting the mailbox location.

It is a second objective of this invention to provide a system that will enable a user to check for mail in a mailbox using a variety of interface devices.

It is a third objective of the present invention to provide a system that can alert the user of mail in a mailbox/container automatically or by remote manual checking via a request for information.

It is a fourth objective of the present invention to provide a method and system that will enable a user to check for the content of mail in a mailbox via a computing network

The mail check system of the present invention allows for remote checking of mail presence thus eliminating wasted trips to the mailbox. This system of the present invention allows one to determine the mail status from a remote location 24 hours a day, 7 days a week. The present invention, referred to as the Mail Check System or MCS, is a system designed to allow the user to determine mail status of a mailbox without having to go to the mailbox. Using the telephone, cell telephone, personal digital assistant (PDA) computer (with special software), computer with website, television website, or a special transmitter/receiver, a person can receive information about the status of the mailbox (if the mailbox contains any mail).

As stated, the MCS can be contacted and information can be retrieved via a conventional telephone, a cellular telephone, a television or special transmitter/receiver. The telephone can be conventional or wireless. A computer or television with special software internet access (wireless or conventional) or website can access the information as well. The portable transmitter for this unit can be used with multiple mailboxes, but is intended for use with single/close proximity mailboxes. The transmitter sends the activating signal to the receiving portion of the mail checking system BCHU or MHU and receives, deciphers and reports results.

The Base Call Handling Unit (BCHU) receives the incoming call or request for information. This unit asks for the user's pin number and transmits the appropriate data to the appropriate MHU. This unit also receives the returning relevant data from the MHU and reports it to the caller. This unit can also be utilized to dial numbers and email customers to notify the subscribers that “they have mail”, having conducted an automatic checking sequence. The memory system can hold numbers and e-mail addresses submitted by subscribers. This unit is designed to work with multiple MHUs. The unit can be accessed with a conventional telephone line or wireless communication.

The Mailbox Hub Unit (MHU) is responsible for receiving the relevant data from the BCHU and contacting the correct Individual Mailbox Sensor (IMS). This unit is also responsible for receiving the relevant data from the IMS and transmitting it to the BCHU. This unit is designed to work with multiple mailbox units. The Individual Mailbox Sensor (IMS) is used to sense the absence or presence of mailbox content and for notifying the MHU. The unit can be accessed with a conventional telephone line/wire or wireless communication. By using light emitting diodes 71 and light sensing devices 69, and optional digital camera70, (light diodes 71 double as light source for camera)70, mechanical means or electrical contacts the IMS can sense the presence and or absence of mail. The unit is able to send a digital picture of the mailbox contents back to the user.

Both institutions and individuals can use the present invention. The personalized version of the system has a portable triggering mechanism that allows for the user to determine mail status from the close proximity locations i.e. a passing car. This unit can be also used from the home with close proximity mailboxes and may have access to as few as one mailbox. The MCS of the present invention can be used on a large scale with businesses and can be linked to an innumerable number of mailboxes from local and distant locations.

### DESCRIPTION OF THE DRAWINGS

FIG. 1 is a pictorial representation of computer that can be used to access the mailbox information provided in the present invention.

FIG. 2 is a representation of personal digital assistant (PDA) that can be used to access the mailbox information provided in the present invention.

FIG. 3 shows a general configuration of mail check system of the present invention.

FIG. 4 shows a general configuration of mail check system of the present invention implemented over a computing system.

FIG. 5 is a flow diagram for the method of the present invention that enables a user to check for mail in a mailbox the without visiting mailbox location.

FIG. 6 is a flow diagram of the information exchange between the mail box hub unit and the mailbox sensor.

FIG. 7 is an alternate flow diagram for the method of the present invention that enables a user to check for mail in a mailbox without visiting the mailbox location.

FIG. 8 is a diagram of the system set up and connection diagram of the various modules involved in the MCS process. (The connections can be wire or wireless)

FIG. 9 is a diagram of the Individual Mailbox Sensor portion of the system

### DETAILED DESCRIPTION OF THE INVENTION

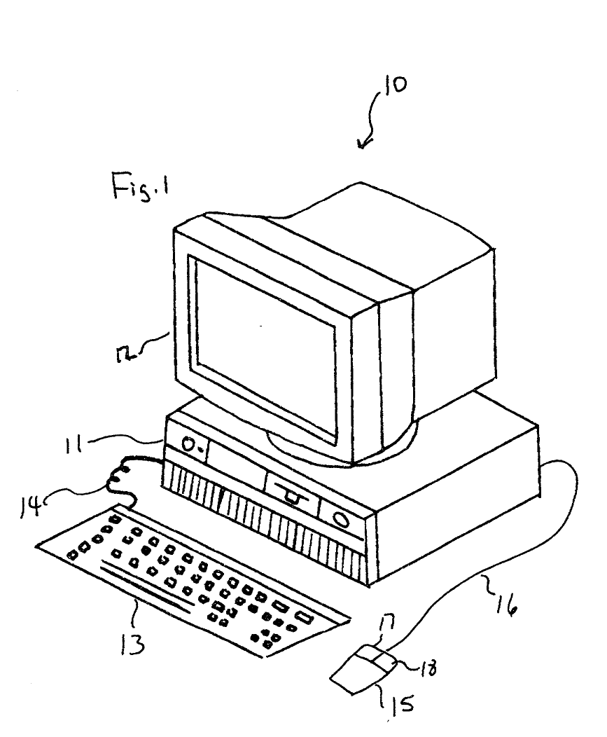

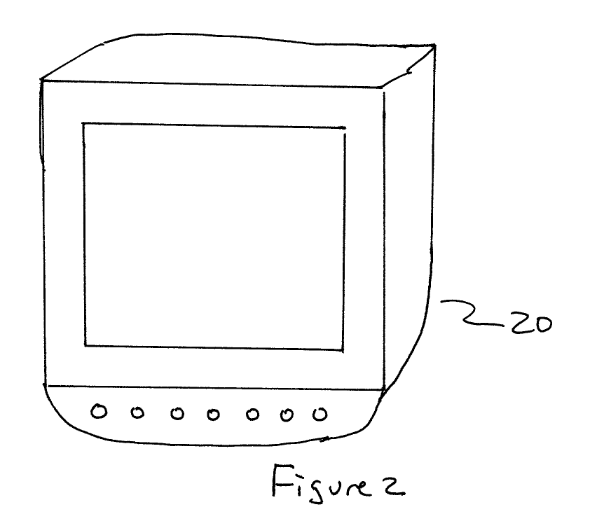

With reference now to FIG. 1, there is depicted a pictorial representation of a computer system 10 which may be used in implementation of the present invention to access and retrieve information about the status of a mailbox. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. A handheld device such as a PDA 20 shown in FIG. 2 or a cellular telephone can also be used to access and retrieve information about the status of a mailbox.

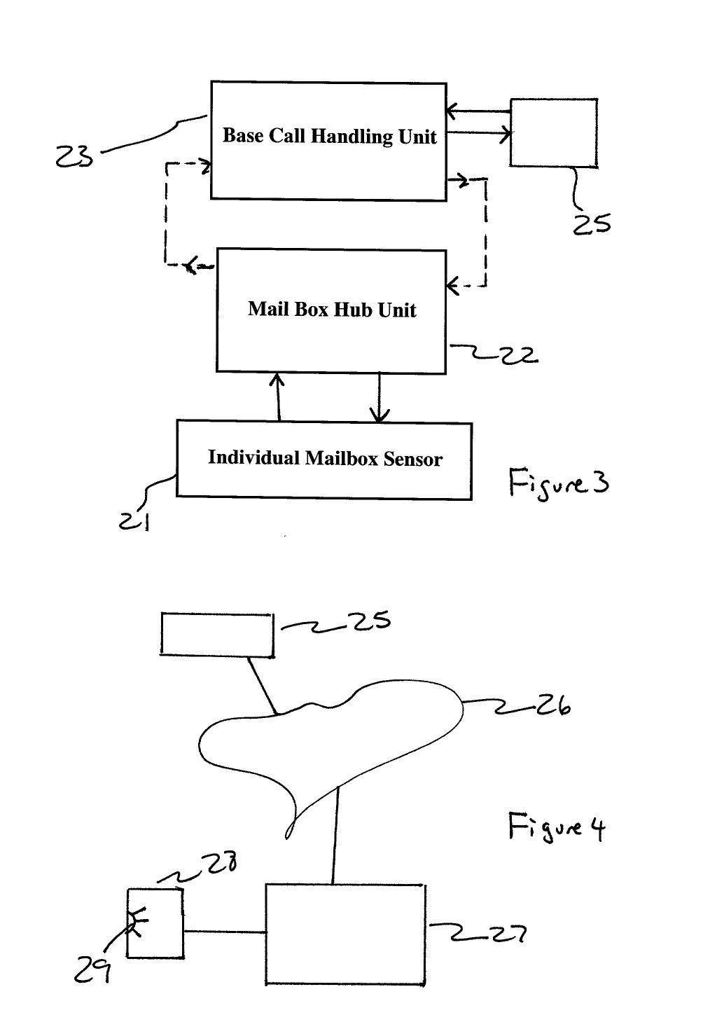

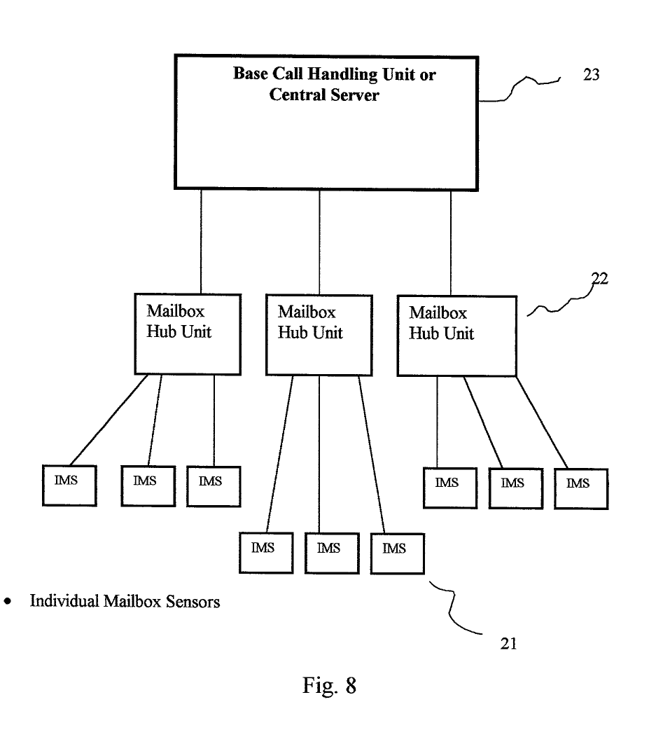

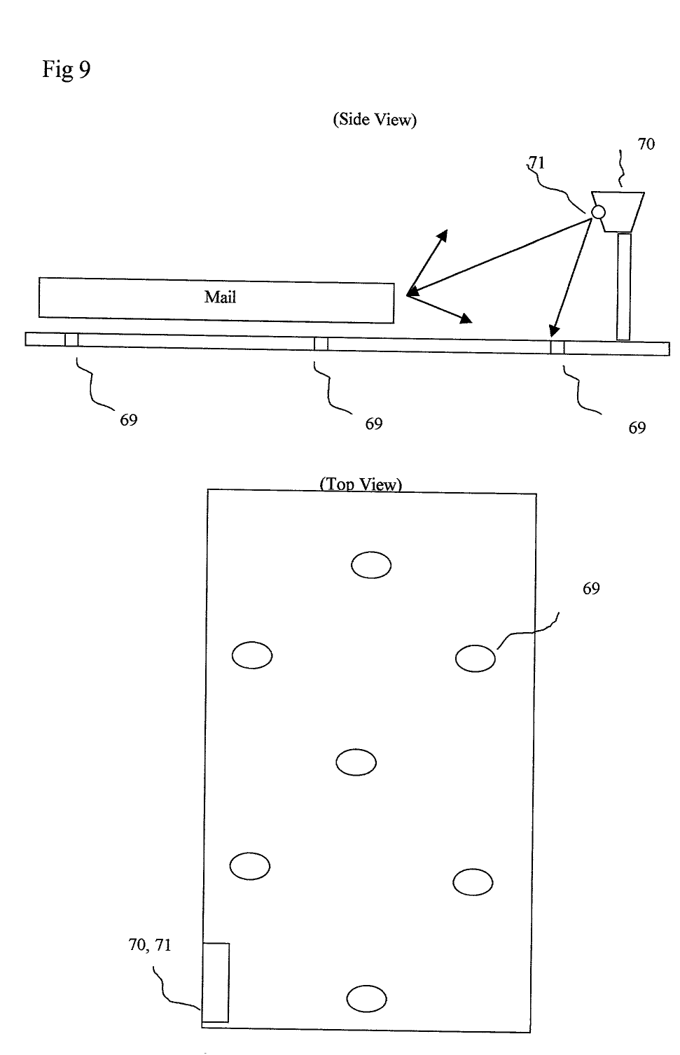

FIG. 3 shows a configuration of the system of the present invention. Within a mailbox is an individual mailbox sensor element 21. As shown in FIG. 9, this sensor element can be any of a variety of sensors 69 that are currently used to perform sensor functions. Preferably the sensor could have a light emitting diode and light sensing device with optional digital camera 70 (to supply user with jpeg of mailbox contents) (light diodes 71 double as light source for camera 70) allowing user to visually check the mailbox content remotely, a mechanical device or an electrical contact that will able to detect whether there is contents in the mailbox. The sensor can also detect when mail is put into the mailbox. FIG. (3,8) The individual sensor element 21 connects to a mailbox hub unit 22. This mailbox hub unit can physically connected to the individual sensor element. The connection between the sensor and the hub unit can also be a wireless connection. The hub is an automated processing device such as a computer. This hub has all of the basic equipment as a conventional computer as shown in FIG. 1. This device has a processor to execute software that will enable the device to communicate with a base call handling unit 23. The software can also process the data/signals received from the individual mailbox sensor 21. Memory capabilities of the hub will allow for the storing of a list mailbox numbers and the content status of each listed mailbox. This unit also has the hardware and software to facilitate communication over a computing network. This hub unit should be located in the general location of the sensor elements. For example, if a group of sensors were installed in an apartment complex, there could be hub unit centrally located at the apartment office. Each sensor would be in communication with the unit. Still referring to FIG. (3,8) the system of the present invention further comprises a base call handling unit or central server 23. This call handling unit 23 communicates with the mailbox hub unit(s) 22 through physical or wireless communication systems. This unit 23 also can be a computing device such as server in a computing network. The base call unit would contain all of the hardware and software needed to perform the functions described herein. This device can contain information about the specific mailbox owners and would serve as the security location to ensure that only the authorized persons have access to the mailbox content information. This unit would handle all front-end functions of the method of the present invention. This task would include verification of the user calling the unit and conformation that the user has a right to access information for the identified mailbox. The base call handling unit would also send the inquiry containing the needed information to the mail box hub. This unit would contain an index of user personal identification numbers and corresponding mailbox numbers. In addition to the actual mailbox number, there can be other means to identify a particular mailbox for which a user would like to access information. The alternate forms to identify a mailbox may be necessary because as shown in FIG. 8, one base call unit could serve several mail box hub units.

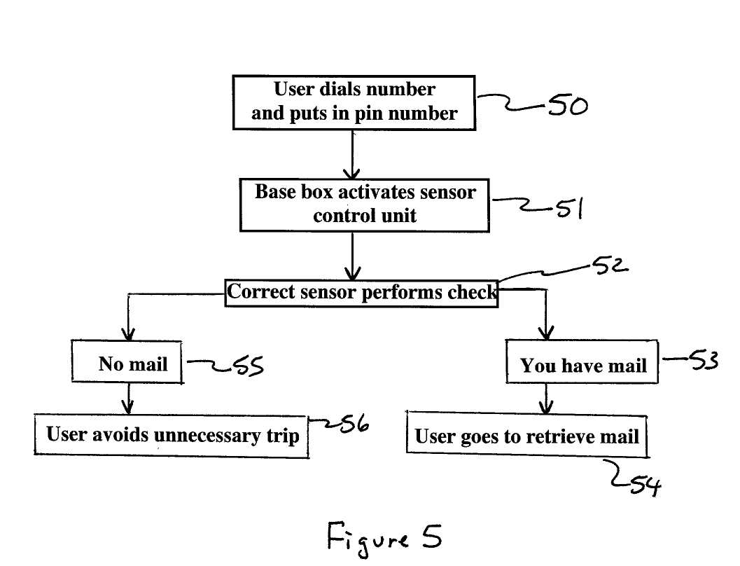

FIG. 4 shows a general configuration of the present invention implemented via a computing network. As shown, the user will access the mailbox status information with an access device 25. As mentioned, this device could be one of several conventional devices currently used to access information from a remote location. The access device 25 would connect to the system via a computing network 26 such as the Internet. A control unit 27 connects to the user access device over the Internet. The control unit can contain both the base call handling unit and the mailbox hub unit. The control unit connects to the mailbox 28 which contains the sensor 29.

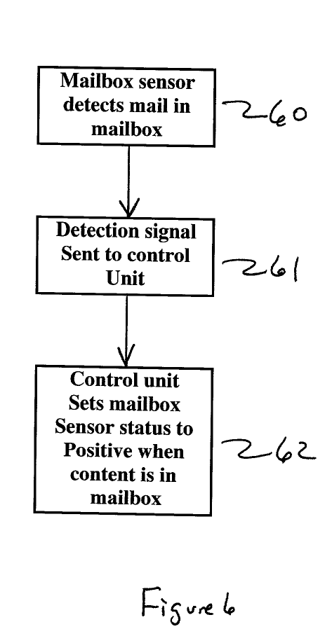

FIG. 5 illustrates the steps involved in the method of the present invention. In the first step 50, the user accesses the base control unit. This base control unit or Central Server can be a combined mailbox hub and call handling unit. This access step can be by telephone or PDA. If the system of the present invention is implemented via a computing network, the user may access the base call handling unit/central server via a web site address for the base call handling unit. In this case, access can be by computer interface device or PDA. In this access step, once the user gains access to the base call handling unit, the user enters a mailbox number and a personal identification number. These numbers are necessary for security purposes and to insure that the person accessing the system has the right to access the identified mailbox. After this access, the base unit activates the sensor for the identified mailbox in step 51. At this point, the sensor performs a check of the mailbox for mail contents 52. This check could be a light emitting diode light signal sent out to detect mail or sound wave emitting device. Each instance would utilize an analyzer to recognize, note and interpret any disturbance, interference, modification or change of the emitted signal before or while attempting to reach the analyzer sensors 69. Another example could be a constant (no mail) state of the mailbox. If this state is disturbed, this would indicate mail be inserted into the mailbox. In any detection configuration, the sensor would send a signal to the base control unit that the mailbox contains mail 53. In this case, when the user accesses the base control unit, the unit would send a response that the mailbox contains mail. The user would then have the option to visit the mailbox and retrieve the mail in step 54. If the sensor in step 52 does not detect any contents in the mailbox, the sensor would send a signal to the base control unit that there is no mail in the mailbox 55. The user could then avoid making an unnecessary trip the mailbox 56.

FIG. 6 shows an alternate method of the present invention in which status of the mailbox is stored at the control unit (mailbox hub unit 42) without the need to check the status at the time of an inquiry by a user. In this method, a mailbox sensor such as a light emitting diode w/light sensing module will detect the insertion of mail into the mailbox 60. The sensor then sends a signal to the control unit in step 61. The control unit will set the mailbox status for that mailbox to positive 62 indicating that the mailbox has contents in it. When the user accesses the control unit, the user will at that time receive a positive or negative response from the control unit without the need for the control unit to contact the sensor.

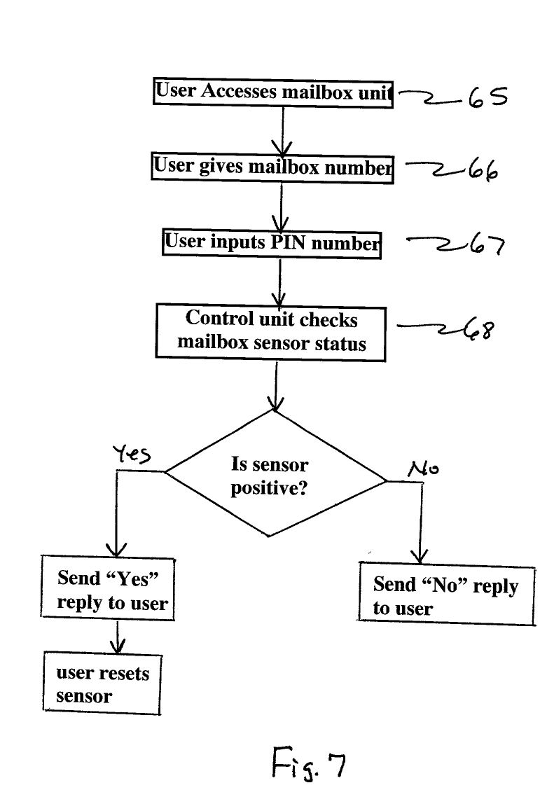

FIG. 7 illustrates the steps involved in the above-described alternate method of the present invention. In the first step 65, the user accesses the base control unit/server. The user then enters a mailbox for which they want to access 66. The user then enters their personal identification number 67. The control unit then checks a mailbox sensor status location to determine whether there is mail in the mailbox 68. This status could be in a record for that particular mailbox stored in a memory location in the unit. The status could be a “1” indicating mail is present in the mailbox. The status could also be “0” which would indicate that the mailbox is empty. If the mailbox status is “1”, the control unit send a “yes” reply to the user. The user can then proceed to retrieve the mail. The user can also reset the status of the sensor and control unit location to “0”. If the mailbox does not have mail, then the status would be “0” and the user would avoid an unnecessary trip to the mailbox.

The system of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A system for determining the presence of contents in a mailbox from a remote location regardless of distance comprising:
a mailbox sensor for detecting the presence of contents in a mailbox, evaluation of mailbox content, said sensor being positioned in the mailbox;
a mailbox control unit in communication with said mailbox sensor for storing information on the status of a mailbox, the status being the presence of contents in the mailbox; and
a remote access device to enable a user to contact said mailbox control unit from a remote location to the mailbox to obtain the status of the mailbox.

2. The system as described in claim 1 wherein said remote access device can be a telephone, personal digital assistant (PDA)/wireless web device or computer terminal.

3. The system as described in claim 1 wherein said sensor further comprises a transmitter to send a signal to said mailbox control unit when said sensor detects the presence of contents in the mailbox.

4. The system as described in claim 1 wherein said sensor can further comprise a light emitting diode, light detection/sensor and digital camera to detect the presence of mail evaluate and identify the contents in the mailbox/container.

5. The system as described in claim 1 wherein said mailbox control unit comprises:
a mailbox hub unit that stores information about the contents of a mailbox; and
a base call handling unit/server that interacts with a user via said remote access device.

6. The system as described in claim 5 wherein said mailbox hub unit and said base call unit can be positioned in different locations and can have wireless communications.

7. The system as described in claim 5 wherein said mailbox hub unit, base call handling unit, remote access unit and individual mail box sensor communicate over a computing network.

8. The system as described in claim 5 further comprising communication software to control communications between said mailbox hub unit, base call handling unit/server, remote access unit and said individual mailbox sensor.

9. The system as described in claim 3 wherein said sensor further comprises a receiver that will enable said sensor to receive instructions from said mailbox control unit or a user.

10. The system as described in claim 5 wherein a user communicates with said system via a global computing networks (i.e. internet) and internal computing networks.

11. A method for determining the presence of contents in a mailbox from a remote location comprising the steps of:
accessing a mailbox control unit containing information about the content status of a mailbox;
identifying a specific mailbox for which the content status of that mailbox is desired;
retrieving content status for the identified mailbox;
sending the retrieved mailbox content status to user accessing the mailbox control unit; and
making a determination whether to retrieve contents from the identified mailbox based on the mailbox content status.

12. The method as described in claim 11 further resetting the mailbox content status after a user has retrieved the contents of the identified mailbox.

13. The method as described in claim 11 further comprising after said mailbox identification step, the steps of:
identifying the user accessing the identified mailbox;
determining whether the identified user has access privilege to the identified mailbox; and
granting access to the user when the identified user does have access to the identified mailbox.

14. The method as described in claim 11 wherein said content status retrieval step further comprises:
activating appropriate mailbox sensor;
performing a contents check by the activated sensor;
sending a mailbox content status signal to box control unit;

15. The method as described in claim 13 wherein said user identification step comprises supplying to the mailbox control unit in communication a personal identification number by the user desiring content information about a mailbox.

16. The system as described in claim 1 wherein the mailbox sensing unit can be made adjustable to fit various sizes of mail boxes.
